(19) United States
(12) Patent Application Publication
(10) Pub. No.: US 2022/0252176 A1
(43) Pub. Date: Aug. 11, 2022

(54) DIRECTIONAL VALVE HAVING A VALVE HOUSING

(71) Applicant: VAT Holding AG, Haag (CH)

(72) Inventors: Martin NETZER, Bludenz (AT); Peter ZVOKELJ, Höchst (AT)

(73) Assignee: VAT Holding AG, Haag (CH)

(21) Appl. No.: 17/608,866

(22) PCT Filed: Apr. 27, 2020
(86) PCT No.: PCT/EP2020/061621

§ 371 Date: Nov. 4, 2021

(30) Foreign Application Priority Data
May 14, 2019 (DE) 10 2019 112 559.6

(51) Int. Cl. F16K 27/06; F16K 5/06; F16K 5/20

(52) U.S. Cl. CPC F16K 27/067; F16K 27/0263; F16K 5/201; F16K 5/0605

(57) ABSTRACT

A directional valve having a valve housing having a primary port and at least one first and one second secondary port and a rotary piece arranged in the valve housing, which is penetrated by a channel and is rotatable about a rotation axis in order to adjust the directional valve between at least first and second switching positions. A first end of the channel is concentric to the axis. The rotary piece has an outer surface which is curved in a spherical cap-shaped manner, at which the second end of the channel opens. The valve housing has an inner surface which is curved in a spherical cap-shaped manner, at which inner surface secondary connection channels of the secondary connections open, and which is opposite the curve outer surface of the rotary piece. The curved outer surface of the rotary piece and the curved inner surface of the valve housing extend at most over the extent of a hemisphere.

### TECHNICAL FIELD

The invention relates to a directional valve having a valve housing which has a primary port with a primary port channel, and has at least one first secondary port with a first secondary port channel and one second secondary port with a second secondary port channel, and having a rotary piece which is arranged in the valve housing and which is extended through by a passage channel and which can be rotated about an axis of rotation for adjusting the directional valve between at least one first switching position and one second switching position, wherein a first end of the passage channel is concentric with the axis of rotation, and wherein, in a respective switching position of the directional valve, the primary port channel is connected to a respective one of the secondary port channels via the passage channel and is separated from the at least one other of the secondary port channels.

### BACKGROUND

Directional valves are known in different embodiments. In a conventional embodiment of a directional valve, a rotary piece in the form of a sphere is rotated about an axis of rotation. In one of the known embodiments, the sphere has an L-shaped channel. The channel is thus formed by two sections which are at right angles to one another. Here, one section of the channel is arranged coaxially with the axis of rotation of the sphere and, in all rotation positions, is connected to a primary port of the directional valve. The other section of the channel is brought into connection with one of the secondary ports according to rotation position. A disadvantage of this prior-art directional valve is the relatively large structural size, in particular if the directional valve has a large nominal width.

### SUMMARY

It is an object of the invention to provide an advantageous directional valve of the type mentioned in the introduction that has a relatively small structural size. According to the invention, this is achieved by a directional valve having one or more of the features disclosed hereon.

In the case of the directional valve according to the invention, the rotary piece has an outer surface which is curved in a spherical cap-shaped manner and at which the second end of the passage channel opens out, and the valve housing has an inner surface which is curved in a spherical cap-shaped manner and at which the secondary port channels open out and which is situated opposite the outer surface, curved in a spherical cap-shaped manner, of the rotary piece. The outer surface, curved in a spherical cap-shaped manner, of the rotary piece and the inner surface, curved in a spherical cap-shaped manner, of the valve housing extend at most over the extent of a hemisphere.

Preferably, the valve housing has a housing top part and a housing bottom part that are connected, in a manner sealed off via a housing sealing ring, to one another. Here, the housing sealing ring is situated in a plane which is at right angles to the axis of rotation of the rotary piece.

On the rotary piece, there is advantageously arranged a support surface which interacts with a bearing surface which is arranged on the housing bottom part. In this way, the rotary piece is supported axially in the direction of the housing bottom side. The support surface and the bearing surface are preferably of planar form and particularly preferably lie in a plane which is at right angles to the axis of rotation.

Expediently, it is provided that, on the rotary piece, there is arranged a primary sealing ring which surrounds the first end of the passage channel and which interacts with a sealing surface of the valve housing that is arranged on the valve housing, preferably on the housing bottom part, or, on the rotary piece, there is arranged a sealing surface which surrounds the first end of the passage channel and which interacts with a primary sealing ring which is arranged on the valve housing, preferably on the housing bottom part. Axial sealing between the rotary piece and the valve housing, preferably the housing bottom part, is thus formed. The sealing surface is preferably of planar form. The primary sealing ring particularly preferably lies in a plane which is at right angles to the axis of rotation. In one possible embodiment of the invention, the sealing surface may lie in a plane which is at right angles to the axis of rotation. In another possible embodiment, the sealing surface could also lie on a cone lateral surface which extends about the axis of rotation.

Instead of axial sealing between the rotary piece and the housing, in particular housing bottom part, radial sealing could also be provided. A cylindrical outer surface of the rotary piece, which is preferably situated in the axial region of the first end of the passage channel, could in this case bear against a cylindrical sealing surface of the valve housing, preferably housing bottom part.

An advantageous embodiment of the invention provides that a drive shaft extending parallel to the axis of rotation departs from the uppermost point of the spherical-cap shaped outer surface of the rotary part and passes in a sealed-off manner through an opening in the valve housing, preferably housing top part.

For radial guidance of the rotary piece with respect to the valve housing, preferably housing top part, provision is expediently made of a radial guide ring surrounding the axis of rotation that is arranged between a valve-housing guide surface situated parallel to the axis of rotation and a rotary-piece guide surface situated parallel to the axis of rotation. The valve-housing guide surface is preferably arranged on the housing bottom part.

First and second secondary sealing rings are expediently arranged on the inner surface, curved in a spherical cap-shaped manner, of the valve housing, preferably of the housing top part, and surround the mouths of the first and second secondary port channels and interact with the outer surface, curved in a spherical cap-shaped manner, of the rotary piece. In a possible embodiment of the invention, it is provided here that the first and second secondary sealing rings can be acted on by a pressure medium via a respective pressure-medium line, wherein a respective one of the sealing rings can be loaded against the outer surface, curved in a spherical cap-shaped manner, of the rotary piece by pressure medium and, in the pressureless state of the pressure-medium line, bears with a comparatively lower pressure against the outer surface, curved in a spherical cap-shaped manner, of the rotary piece or is at a distance therefrom. In this way, the pressing pressure of the first and second secondary sealing rings against the outer surface of the rotary piece can be reduced, or even removed, when the directional valve is actuated. This allows the shear loading acting on the first and second secondary sealing rings to be reduced significantly.

The directional valve is preferably designed for guiding fluids in the form of gases. The pressure range for which the directional valve is designed may for example be in the range of 10⁻² mbar to 2 bar. Operation in a narrower pressure range, for example of 0.1 bar to 1.1 bar may also be provided.

The diameter of the passage channel, just like the diameter of the primary port channel and the diameters of the secondary port channels, is preferably at least 25 mm, particularly preferably at least 35 mm.

### BRIEF DESCRIPTION OF THE DRAWINGS

Further advantages and details of the invention will be discussed below on the basis of the appended drawing, in which:

FIG. 1 shows an oblique view of a directional valve according to the invention;

FIGS. 2 and 3 shows exploded illustrations from different viewing directions;

FIG. 4 shows a side view;

FIG. 5 shows a section along the line AA in FIG. 4;

FIG. 6 shows a partial section along the line BB in FIG. 4;

FIG. 7 shows a view from below;

FIG. 8 shows a section along the line CC in FIG. 7, wherein the directional valve is in the first switching position;

FIG. 9 shows a section analogous to FIG. 8, wherein the directional valve is in the second switching position;

FIGS. 10 and 11 show an oblique view and a side view of the rotary piece (without primary sealing ring);

FIG. 12 shows a section along the line DD in FIG. 11;

FIG. 13 shows a side view, rotated through 90° in relation to FIG. 11, of the rotary piece;

FIGS. 14 and 15 shows sections along the lines EE and FF in FIG. 13;

FIG. 16 shows a side view of the housing top part;

FIG. 17 shows a section along the line GG in FIG. 16 (without secondary sealing ring and additional sealing ring);

FIG. 18 shows a further possible embodiment of a secondary sealing ring.

### DETAILED DESCRIPTION

The figures are partially simplified and schematically illustrated.

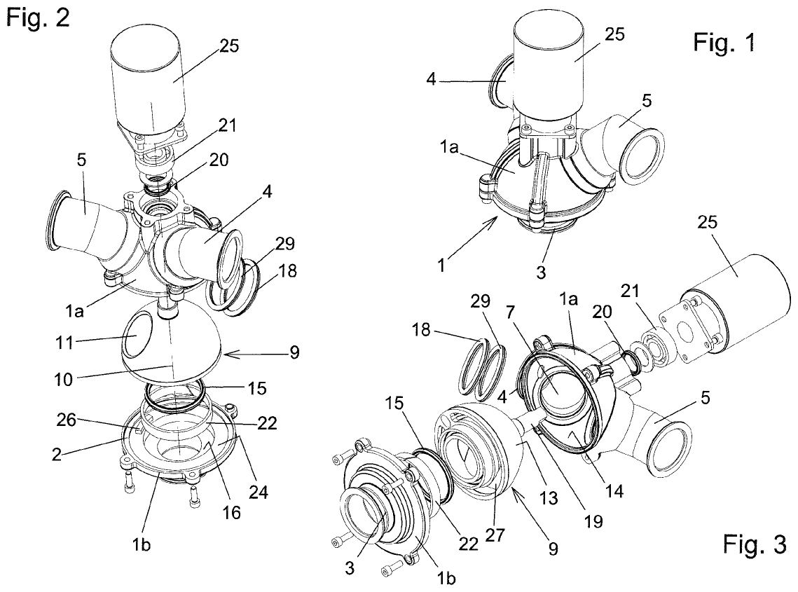

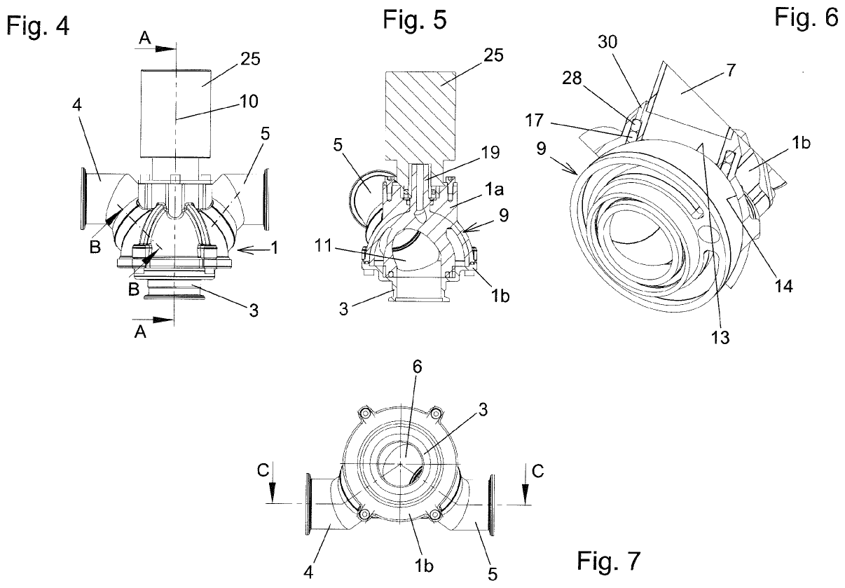

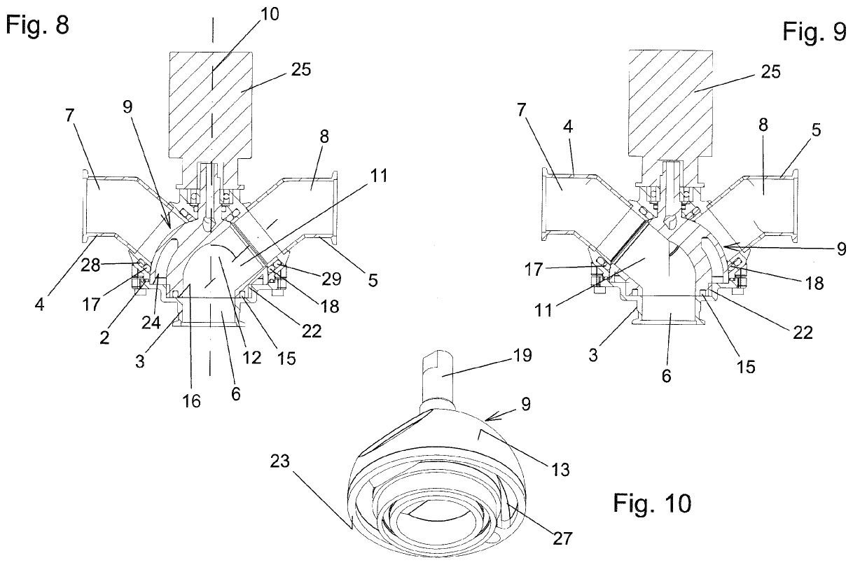

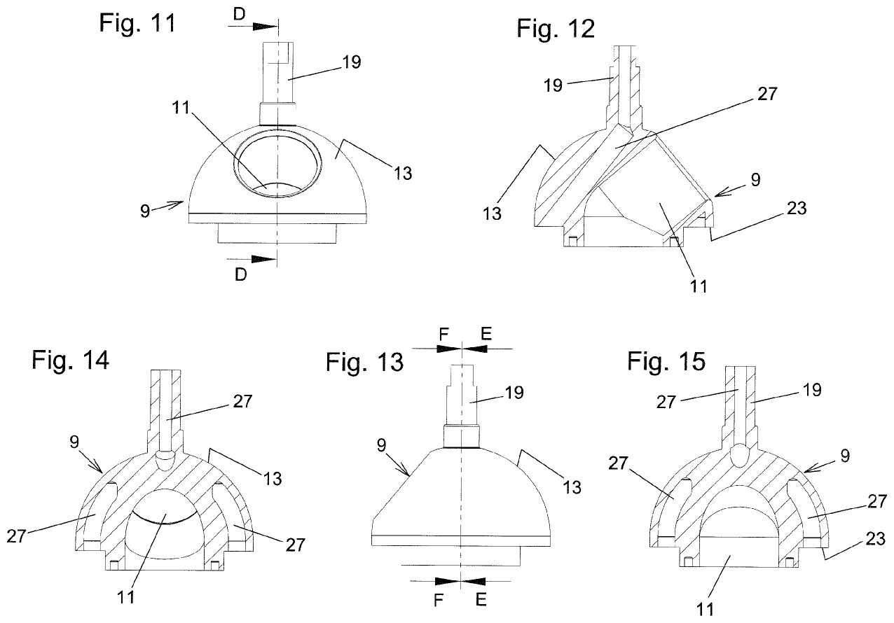

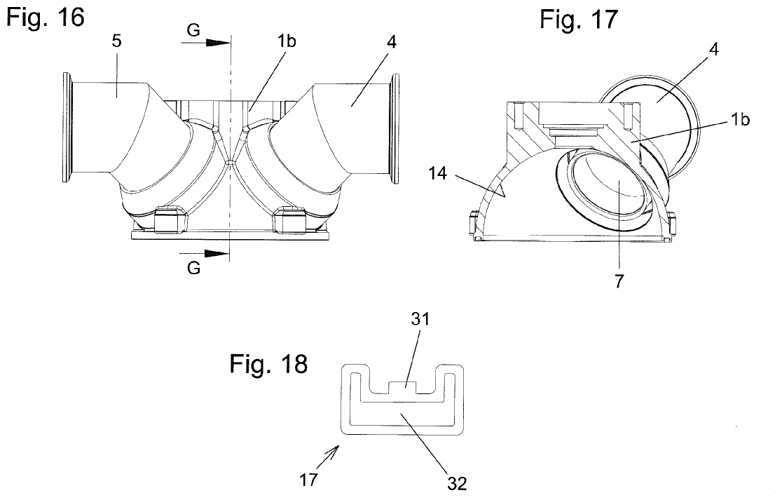

FIGS. 1 to 17 illustrate an exemplary embodiment of a directional valve according to the invention. The directional valve has a valve housing 1. The valve housing 1 comprises a housing top part 1a and a housing bottom part 1b. These are screwed to one another and are sealed off with respect to one another by way of a housing sealing ring 2 arranged therebetween.

The valve housing 1 has a primary port 3 and first and second secondary ports 4, 5. The primary port 3 forms a primary port channel 6, and the first and second secondary ports 4, 5 form first and second secondary port channels 7, 8.

In the exemplary embodiment, the primary port 3 and the secondary ports 4, 5 each have tube pieces with port flanges arranged at their free ends. Embodiments of the ports that differ from the ones shown are conceivable and possible.

A rotary piece 9 is arranged in the valve housing 1. Said rotary piece can be rotated about an axis of rotation 10 for adjusting the directional valve between a first switching position and a second switching position. The rotary piece 9 has a passage channel 11. In the first switching position, the primary port channel 6 is connected to the first secondary port channel 7 by the passage channel 11. In the second switching position, the primary port channel 6 is connected to the second secondary port channel 8 by the passage channel 11.

At least the mouth of the primary port channel 6 into the housing interior is concentric with the axis of rotation 10. In the exemplary embodiment, the entire primary port, with the entire primary port channel 6, is concentric with the axis of rotation 10.

A first end of the passage channel 11, which first end adjoins the mouth of the primary port channel 6, is concentric with the axis of rotation 10. Preferably, the mouth of the primary port channel 6 into the housing interior and the first end of the passage channel 11 are aligned with one another, as can be seen from the figures.

The primary port channel 6 is thus connected to the passage channel 11 both in the first switching position and in the second switching position of the directional valve.

That section of the central axis of the passage channel 11 which adjoins the first end of the passage channel 11 is parallel to the axis of rotation and is on a common straight line therewith. The passage channel 11 has over its extent from the first end to the second end at least one bent or angled section. That section of the central axis of the passage channel which is in the region of the second end of the passage channel includes with the axis of rotation 10 an angle 12 which, expediently, is at least 35°, preferably at least 45°.

Preferably, the diameter of the passage channel 11 is at least substantially constant over its entire extent.

The second end of the passage channel 11 opens out at an outer surface 13 of the rotary piece 9, which outer surface is curved in a spherical cap-shaped manner. Said outer surface is situated opposite an inner surface 14 of the housing top part 1a, which inner surface is curved in a spherical cap-shaped manner. The secondary port channels 7, 8 open out at said inner surface 14, wherein the mouths of said secondary port channels are offset from one another, advantageously by at least 90°, preferably by at least 100°, about the axis of rotation 10.

The rotary piece 9 is sealed off with respect to the housing bottom part 1b by means of a primary sealing ring 15. In the exemplary embodiment, the latter is arranged on the rotary piece 9 and bears against a planar sealing surface 16 of the housing bottom part 1b. Here, the primary sealing ring and the sealing surface 16 each lie in a plane which is at right angles to the axis of rotation 10.

Instead of this, the sealing surface 16 could also be arranged on the rotary piece 9 and the primary seal 15 could be arranged on the housing bottom part 1b.

On the rotary piece 9, there is arranged a support surface 23 which interacts with a bearing surface 24 which is arranged on the housing bottom part. The support surface 23 and bearing surface 24 are of planar form and lie in a plane which is at right angles to the axis of rotation 10. In the exemplary embodiment, the support surface 23 of the rotary piece 9 is situated in a radially outer edge region of the rotary piece 9.

First and second secondary sealing rings 17, 18 are arranged on the inner surface 14, curved in a spherical cap-shaped manner, of the housing top part 1a. The first secondary sealing ring 17 surrounds the mouth, situated on the inner surface 14, of the first secondary port channel 7. The second secondary sealing ring surrounds the mouth, situated on the inner surface 14, of the second secondary port channel 8. The first and second secondary sealing rings 17, 18 interact with the outer surface 13, curved in a spherical cap-shaped manner, of the rotary piece 9, which outer surface forms a sealing surface.

In the first switching position, the first secondary port channel 7 is connected to the passage channel 11, wherein these channels are preferably aligned with one another in the connection region. The second secondary port channel 8 is closed off by the outer surface 13, curved in a spherical cap-shaped manner, of the rotary piece 9.

In the second switching position, the second secondary port channel 8 is connected to the passage channel 11, wherein these two channels are preferably aligned with one another in the connection region. The first secondary port channel 7 is closed off by the outer surface 13, curved in a spherical cap-shaped manner, of the rotary piece 9.

A drive shaft 19 extending parallel to the axis of rotation 10 departs from the uppermost point of the spherical cap-shaped outer surface 13 of the rotary piece 9. The drive shaft 19 is led in a sealed-off manner through an opening in the housing top part. The opening in the housing top part is consequently concentric with the axis of rotation 10. A sealing ring 20, which is arranged here on the housing top part 1a and which interacts with a sealing surface surrounding the drive shaft 19, serves for sealing off the drive shaft 19 with respect to the housing top part 1a. In principle, the sealing ring 20 could also be arranged on the drive shaft and the sealing surface could be arranged on the housing top part 1a.

The drive shaft thus departs from the rotary piece 9 on the side situated opposite the first end of the passage channel 11.

In the exemplary embodiment, a ball bearing 21 for rotatable mounting of the drive shaft 19 is arranged in the housing top part 1a outside the housing with respect to the sealing ring 20.

A guide ring 22 furthermore serves for radial guidance of the rotary piece 9. The face-side narrow surfaces thereof face in directions parallel to the axis of rotation 10. The guide ring 22 surrounds the axis of rotation 10 concentrically and is arranged between a valve-housing guide surface, which is situated parallel to the axis of rotation 10 and is arranged on the housing bottom part 1b, and a rotary-piece guide surface, which is situated parallel to the axis of rotation 10 and is arranged on the rotary piece 9.

The drive shaft 19, for adjustment of the directional valve between the first and second switching positions, is driven by a drive motor 25 (indicated merely symbolically in the figures). The drive motor 25 may for example be a pneumatic motor.

For limiting the rotation of the rotary piece 9, use may be made of at least one stop 26 which is arranged on the valve housing 1, preferably housing bottom part 1b, and which abuts against counterpart stops of the rotary piece in the end positions of the rotary piece 9. The counterpart stops may be formed for example by edges of a recess in the rotary piece 9.

In the exemplary embodiment shown, the first and second secondary sealing rings 17, 18 may be pressed by means a pressure medium, for example compressed air, onto the outer surface 13 of the rotary piece 9 so as to establish the sealing with respect to the rotary piece 9. For this purpose, the first and second secondary sealing rings 17, 18 are each mounted displaceably in a recess of the housing top part 1a. In order to improve the security of the sealing, an additional sealing ring 28 may be arranged on that side of the respective secondary sealing ring 17, 18 which is remote from the rotary piece 9. This could also be omitted. The cavity in which the respective secondary sealing ring 17, 18 and, possibly, additional sealing ring 28, 29 are/is arranged may be charged with a pressure medium via a pressure-medium line 30, of which only the end section situated in the housing top part 1a is illustrated in the figures. When the rotary piece 9 is rotated about the axis of rotation 10, the respective pressure-medium line 30 is relieved of load. In this way, the pressing pressure of the respective secondary sealing ring 17, 18 on the rotary piece 9 is removed.

In the exemplary embodiment, the rotary piece 9 has recesses (cavities) 27. In this way, the mass of the rotary piece 9 is reduced. Such a cavity may also be provided for receiving a heating cartridge by way of which the directional valve can be heated. For the feeding of the lines to the heating cartridge, the drive shaft 19 may be of hollow form as illustrated.

FIG. 18 illustrates a further possible exemplary embodiment for a secondary sealing ring 17 which can be acted on by a pressure medium. Here, the secondary sealing ring 17 is of hose-like form. The secondary sealing ring is “inflated” by introduction of pressure medium into the inner cavity 32, wherein a sealing section 31 is pressed onto the outer surface of the rotary piece. In the deflated state, the sealing section may be at a distance from the outer surface of the rotary piece. The second secondary sealing ring 18 may be formed in the same manner.

Different further modifications of the invention are conceivable and possible without departing from the scope of the invention. In this regard, it would be possible for example for the rotary piece 9 to be sealed off with respect to the housing bottom part 1b by radial sealing instead of by axial sealing. For example, for this purpose, provision could be made in a region beside the guide ring 22 of a primary sealing ring which bears against the bearing surface 24 of the housing bottom part 1b, wherein said bearing surface 24 forms a sealing surface in this case.

The cylindrical cap-shaped outer surface 13 of the rotary piece could be lengthened by a cylindrical projection, in the region of which it is possible to arrange the guide ring 22 and/or a primary sealing ring for radially sealing off the rotary piece 9 with respect to the valve housing, in particular housing bottom part 1b.

### LEGEND FOR THE REFERENCE SIGNS

1 Valve housing
1a Housing top part
1b Housing bottom part
2 Housing sealing ring
3 Primary port
4 First secondary port
5 Second secondary port
6 Primary port channel
7 First secondary port channel
8 Second secondary port channel
9 Rotary piece
10 Axis of rotation
11 Passage channel
12 Angle
13 Outer surface
14 Inner surface
15 Primary sealing ring
16 Sealing surface
17 First secondary sealing ring
18 Second secondary sealing ring
19 Drive shaft
20 Sealing ring
21 Ball bearing
22 Guide ring
23 Support surface
24 Bearing surface
25 Drive motor
26 Stop
27 Recess
28 Additional sealing ring
29 Additional sealing ring
30 Pressure-medium line
31 Sealing section
32 Cavity

1. A directional valve, comprising:
a valve housing which has a primary port with a primary port channel, and has at least one first secondary port with a first secondary port channel and one second secondary port with a second secondary port channel;
a rotary piece arranged in the valve housing and which is extended through by a passage channel and which is rotatable about an axis of rotation for adjusting the directional valve between at least one first switching position and one second switching position;
a first end of the passage channel is concentric with the axis of rotation;
wherein in a respective switching position of the directional valve, the primary port channel is connected to a respective one of the secondary port channels via the passage channel and is separated from the at least one other of the secondary port channels;
the rotary piece has an outer surface which is curved with a spherical cap-shape and at which a second end of the passage channel opens out;
the valve housing has an inner surface which is curved with a spherical cap-shape and at which the secondary port channels open out and which is situated opposite the outer surface, curved with the spherical cap-shape, of the rotary piece; and
the outer surface, curved with the spherical cap-shape, of the rotary piece and the inner surface, curved with the spherical cap-shape, of the valve housing extend at most over an extent of a hemisphere.

2. The directional valve as claimed in claim 1, wherein a housing top part of the valve housing includes the inner surface, curved with the spherical cap-shape, and is sealingly connected via a housing sealing ring to a housing bottom part which includes the primary port.

3. The directional valve as claimed in claim 2, wherein a support surface on the rotary piece interacts with a bearing surface arranged on the housing bottom part, and the support surface and the bearing surface have a planar form.

4. The directional valve as claimed in claim 3, wherein the support surface and the bearing surface lie in a plane which is at right angles to the axis of rotation.

5. The directional valve as claimed in claim 1, further comprising a primary sealing ring arranged on the rotary piece which surrounds the first end of the passage channel and which interacts with a sealing surface arranged on the valve housing, or a sealing surface arranged on the rotary piece which surrounds the first end of the passage channel and interacts with a primary sealing ring arranged on the valve housing.

6. The directional valve as claimed in claim 1, further comprising a drive shaft extending parallel to the axis of rotation from an uppermost point of the spherical cap-shaped outer surface of the rotary piece and passing in a sealed-off manner through an opening in the valve housing.

7. The directional valve as claimed in claim 1, wherein the central axis of the passage channel is parallel to the axis of rotation in a region of the first end of the passage channel and includes an angle of at least 35° with the axis of rotation in a region of the second end of the passage channel.

8. The directional valve as claimed in claim 1, further comprising a guide ring surrounding the axis of rotation arranged between a valve-housing guide surface situated parallel to the axis of rotation and a rotary-piece guide surface situated parallel to the axis of rotation.

9. The directional valve as claimed in claim 1, further comprising a first secondary sealing ring surrounding a mouth of the first secondary port channel and a second secondary sealing ring surrounding a mouth of the second secondary port channel arranged on the inner surface, curved with the spherical cap-shape manner, of the valve housing that interact with the outer surface, curved with the spherical cap-shape, of the rotary piece.

10. The directional valve as claimed in claim 9, wherein the first and second secondary sealing rings are loaded against the outer surface, curved with the spherical cap-shape, of the rotary piece by a pressure medium via a respective pressure-medium line, wherein, in a pressureless state of the pressure-medium line, the respective secondary sealing ring bears with a comparatively lower pressure against the outer surface, curved with the spherical cap-shape, of the rotary piece or is at a distance therefrom.
